(19) United States
(12) Patent Application Publication
(10) Pub. No.: US 2008/0076300 A1
(43) Pub. Date: Mar. 27, 2008

(54) Car inside lamp adaptor device

(76) Inventor: A-Sheng Yang, Taipei Hsien (TW)

Correspondence Address: A-Sheng Yang, 235 Chung-Ho, Box 8-24, Taipei, omitted

(21) Appl. No.: 11/526,911

(22) Filed: Sep. 26, 2006

(51) Int. Cl. H01R 13/66

(52) U.S. Cl. 439/620.02

(57) ABSTRACT

A car inside lamp adaptor device comprises an adaptor having a hollow seat and having a positive electrode and a negative electrode; a wire set having an electrode pin at one end thereof and another end of the wire set extending with two wires which are connected to the positive electrode and negative electrode; respectively; an elastic unit filling in a hollow seat and enclosing the positive electrode and negative electrode in an inner layer of the seat and being integrally formed with the seat; and a cap for receiving one end of the electrode pin, a ring in a hollow portion of the seat; one side of the seat having a via hole for receiving the wire set; two springs being installed in the hollow center of the seat; and each spring being fixed to the ring in the seat and another end thereof being fixed to the post.

### FIELD OF THE INVENTION

The present invention relates to car lights, and particularly to a car inside lamp adaptor device, wherein by the assembly and filling design of an elastic unit and wire set, the installation and updating of the adaptor can be performed easily and quickly.

### BACKGROUND OF THE INVENTION

Light emitting diode lights have become a main trend of car lights. Referring to FIG. 1, the car inside lamp adaptor device of the prior art has a joint 1 and an LED plate (not shown). The joint 1 has a seat 10. Two lateral sides of the seat have respective metal caps 12. An interior thereof is installed with a female seat. A lower end of the male seat 11 has an electrode pin which is an inner edge 122 of two metal caps 12 by wires 13. The two caps 12 cover upon the engage portions at two sides of the seat 10. An LED lamp (not shown) is installed with a connecting seat. A male seat 15 is installed at a distal end of a connecting wire so that the male seat 15 of the LED lamp plate is embedded into the female seat 11 of the electric terminal 1.

However, the prior art female seat 11 of the electric terminal 1 is embedded into the seat 10 of the electric terminal 1. The distal end of the connecting wire of the LED lamp plate is installed with the male seat 15. The connecting seat cannot be separated so that when one end of the connecting seat has fault, it must be replaced by a same one. This is inconvenient. When the terminal 1 is installed in a power source within a car, the electric terminal will be heated in high temperature and is eroded by acid rain. Furthermore the connecting seat of the terminal is made of plastics. When the terminal is pulled out, the female seat 11 is easy to break or have electric leakage so as to affect the wiring quality in the connection.

### SUMMARY OF THE INVENTION

Accordingly, the primary object of the present invention is to provide a car inside lamp adaptor device, wherein by the assembly and filling design of an elastic unit and wire set, the installation and updating of the adaptor can be performed easily and quickly.

To achieve above object, the present invention provides a car inside lamp adaptor device which comprises an adaptor having a hollow seat and having a positive electrode and a negative electrode; a wire set having an electrode pin at one end thereof and another end of the wire set extending with two wires which are connected to the positive electrode and negative electrode; respectively; an elastic unit filling in a hollow seat and enclosing the positive electrode and negative electrode in an inner layer of the seat and being integrally formed with the seat; and a cap for receiving one end of the electrode pin. a ring in a hollow portion of the seat; one side of the seat having a via hole for receiving the wire set; two cover posts being at two ends of the seat; one end of each post being an opening; an inner diameter of the opening is greater than an outer diameter of the seat; another end of the each post being a sealing end; a center of the sealing end being installed with an ejecting point; and two springs being installed in the hollow center of the seat; one end of each spring being fixed to the ring in the seat and another end thereof being fixed to the post.

The various objects and advantages of the present invention will be more readily understood from the following detailed description when read in conjunction with the appended drawing.

### BRIEF DESCRIPTION OF THE DRAWINGS

FIG. 1 is an assembled perspective view of the prior art adaptor.

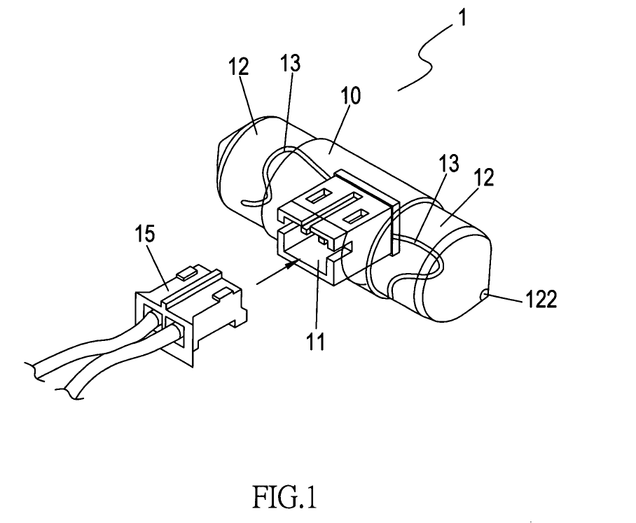

FIG. 2 is an exploded perspective view of the car inside lamp adaptor device of the first embodiment of the present invention.

FIG. 3 is a perspective view of the car inside lamp adaptor device in the first embodiment of the present invention.

FIG. 4 is an exploded schematic view of the car inside lamp adaptor device of the present invention.

FIG. 5 is an exploded schematic view of the present invention.

FIG. 6 is an exploded schematic view about the car inside lamp adaptor device of the second embodiment of the present invention.

FIG. 7 is an assembled perspective view of the car inside lamp adaptor device in the second embodiment of the present invention.

FIG. 8 is an exploded schematic view of the car inside lamp adaptor device in the third embodiment of the present invention.

FIG. 9 is a schematic perspective view of the adaptor in the third embodiment of the present invention.

FIG. 10 is an exploded schematic view about the fourth embodiment of the present invention.

FIG. 11 is an assembled perspective view of the car inside lamp adaptor device in the fourth embodiment of the present invention.

FIG. 12 is a schematic perspective view showing that the present invention is assembled with an LED lamp plate.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

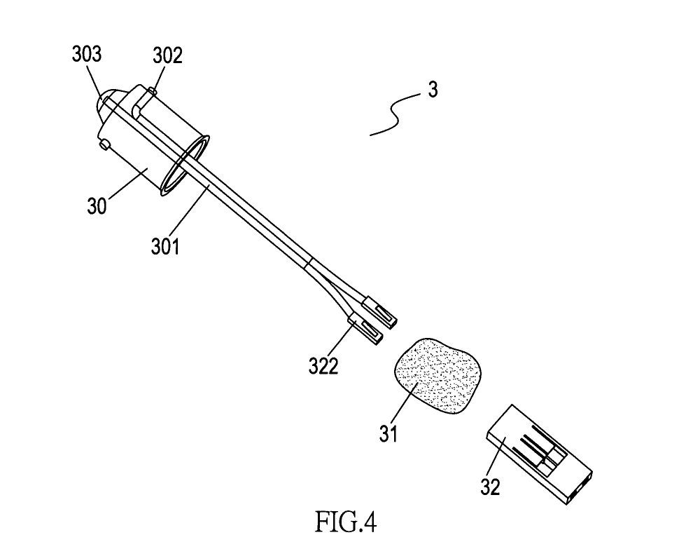

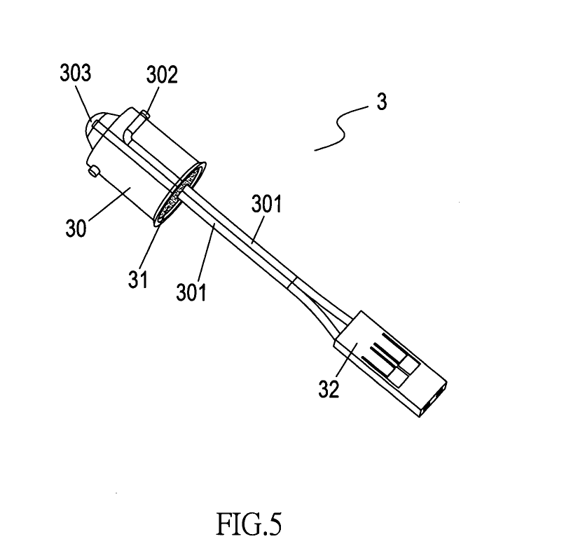

Referring to FIGS. 4 and 5, car inside lamp adaptor of the present invention is illustrated. The present invention has the following elements.

An adaptor 3 has a hollow seat 30 which has a positive electrode 303 and a negative electrode 302.

A wire set 301 has an electrode pin 322 at one end thereof and another end of the wire set 301 have two wires which are connected to the positive electrode 303 and the negative electrode 302, respectively. The wire set 301 is welded to the seat 30.

An elastic unit 31 is made mainly by epoxy which is interfere-proof and erode-proof. The elastic unit 31 is installed in the hollow seat 30 of the adaptor 3. The elastic unit 31 encloses the wire set 301. The elastic unit 31 has the effect of buffering and erode-tolerance which is better than the plastics or rubber in electric insulation.

A hat 32 serves for receiving the electrode pin 322 at one end of the wire set 23. The hat 32 is a male hat or a female hat.

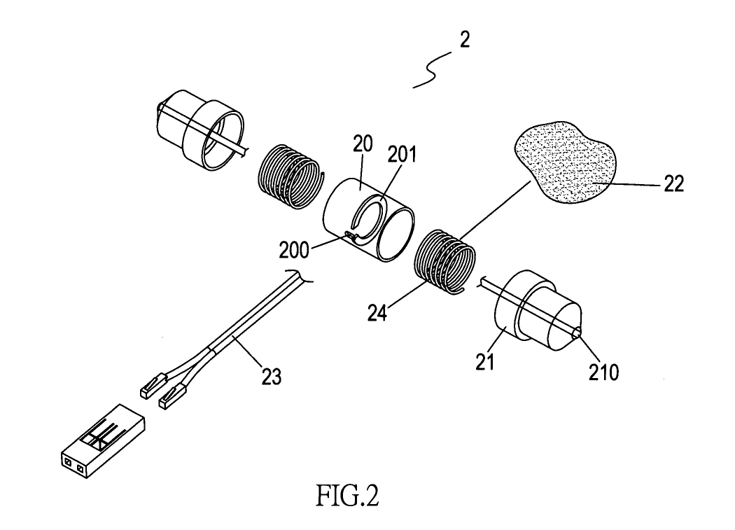

Referring to FIG. 2, another embodiment about the adaptor 2 of the present invention is illustrated. The adaptor 2 has the following elements.

A seat 20 is a hollow cylinder. A ring is received in the seat 20. One end of the seat 20 is a via hole 200 for receiving a wire set 23.

Two cover posts 21 are at two ends of the seat 20. One end of each post 21 is an opening. An inner diameter of the opening is greater than an outer diameter of the seat 20. Another end of the each post 21 is a sealing end. A center of the sealing end is installed with an ejecting point 210.

Two springs 24 are installed in the hollow center of the seat 20. One end of each spring 24 is fixed to the ring 201 in the seat 20 and another end thereof is fixed to the post 21.

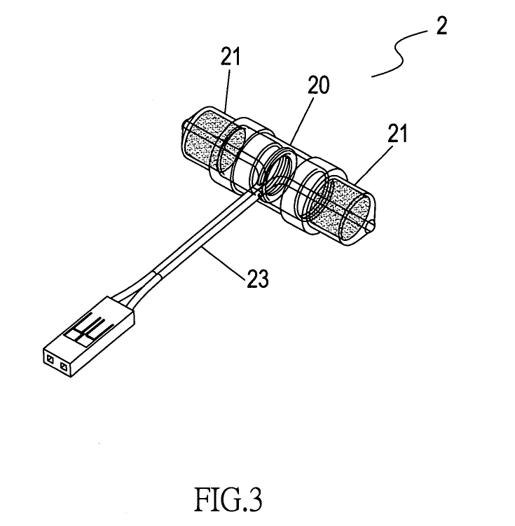

Referring to FIG. 3, the wire set 23 passes through the seat 20. Two wires are extended from the seat 20. The wires are welded to the ejecting points 210 at the sealing ends of the cover posts 21. The cover posts 21 seal two ends of the seat 20 so as to form an adaptor 2.

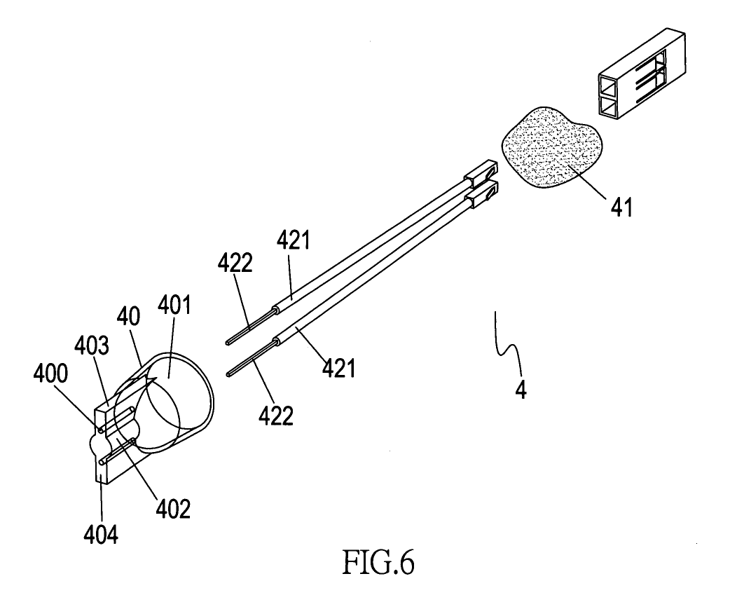

Referring to FIG. 6, another embodiment about the adaptor 4 of the present invention is illustrated. The adaptor 4 has the following elements.

A seat 40 has a recess 401 at one end thereof. Another end of the seat 40 has a rectangular block 403. One side of the block 403 has a rib 402. The block 403 has two penetrating holes 400 which are communicated to the recesses 401.

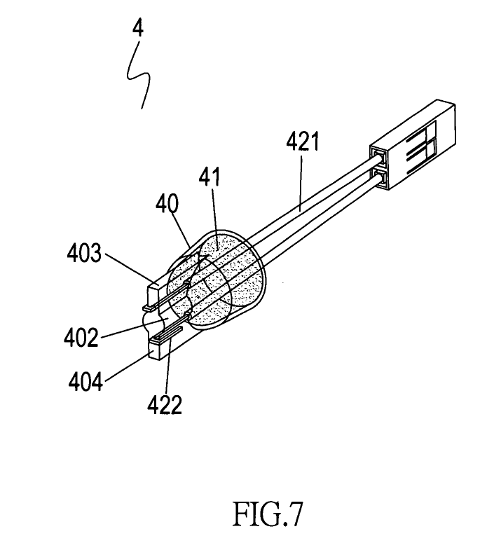

Referring to FIG. 7, one end of each of two conductive wire 421 has a bare welding conductor 422. The welding conductor 422 passes through the recess 401 of the seat 40 and then extends to the through hole 400 of the block 403. At a surface of the block 403,the welding conductor 422 bends as a hook through two 90 degrees folds so as to combine with the block 403. Two lateral sides of the block 403 expose with respective welding conductor 422. An elastic unit is filled in the seat so as to form an adaptor 4.

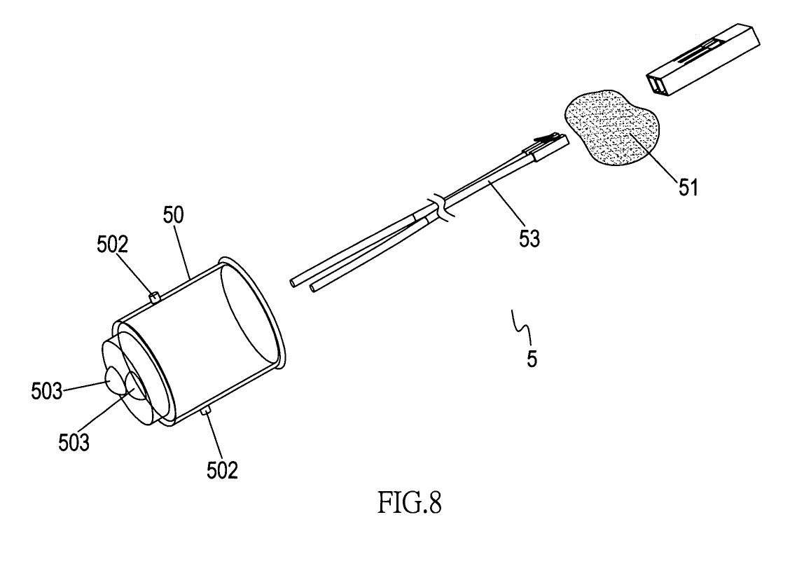

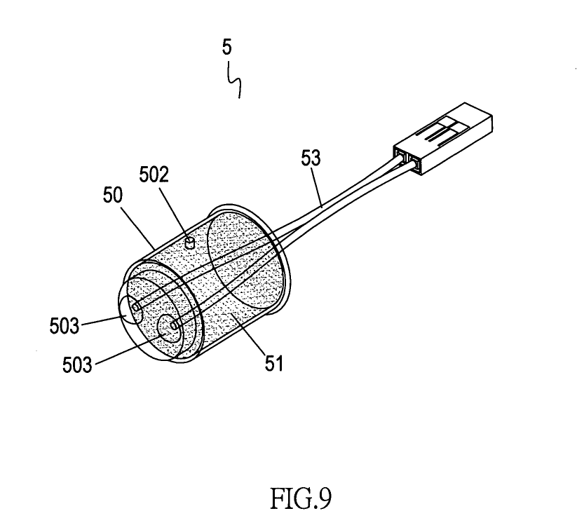

Referring to FIGS. 8 and 9, another embodiment of an adaptor is illustrated. The adaptor 5 has the following elements.

A seat 50 is a hollow cylinder. The seat 50 has a positive electrode 503 and a negative electrode 502.

A wire set 53 has an electrode pin 531 at one end thereof and another end of the wire set 53 have two wires which are connected to the positive electrode 503 and the negative electrode 502, respectively. The wire set 53 is welded to the seat 50.

An elastic unit 51 is made mainly by epoxy which is interfere-proof and erode-proof. The elastic unit 51 is installed in the hollow seat 50 of the adaptor 5. The elastic unit 51 encloses the wire set 53. The elastic unit 51 has the effect of buffering and erode-tolerance which is better than the plastics or rubber in electric insulation.

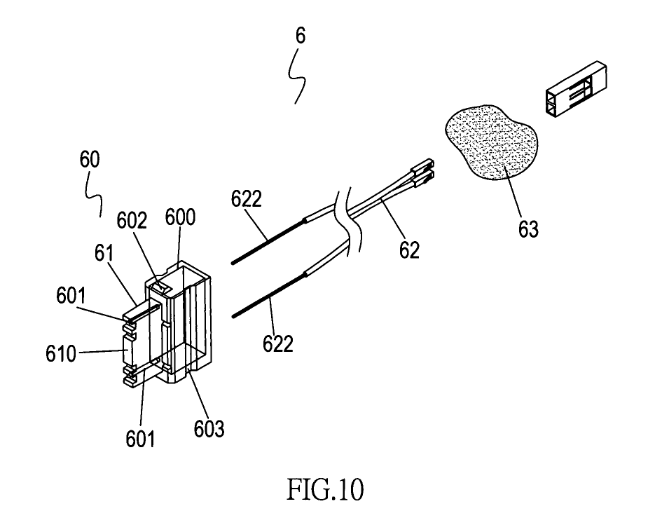

Referring to FIG. 10, another embodiment about the adaptor 6 of the present invention is illustrated. The adaptor 6 of the present invention has the following elements.

An embedded seat 60 has a hole 600 at one end thereof. An outer surface of the seat 60 has at least one recess 603 and at least one rib 602. A lateral side of the seat 60 is extended with a rectangular block 61. The block 601 has two via hole 601 which are communicated to the hole 600.

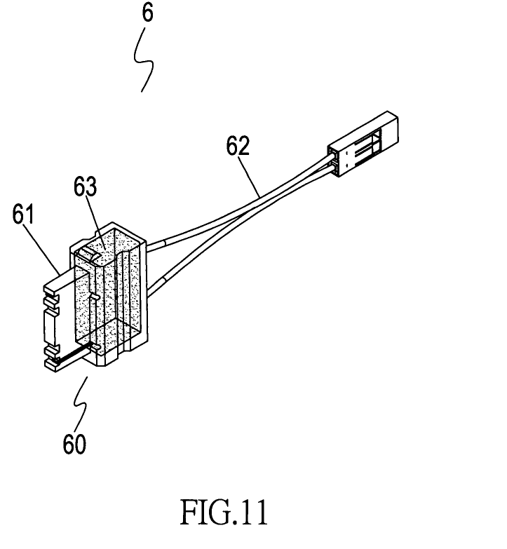

Referring to FIG. 11, each of two wires 62 has a bare welding conductor 622 which passes through the hole 600 of the seat 60 and then extends to the via hole 601 of the block 61 and then bends through 90 degrees along a surface of the block 61 so as to be combined with the block 61. Two sides of the block 61 are exposed with respective welding conductors 622. An elastic unit 63 is filled in the seat 60 so as to form as an adaptor 6.

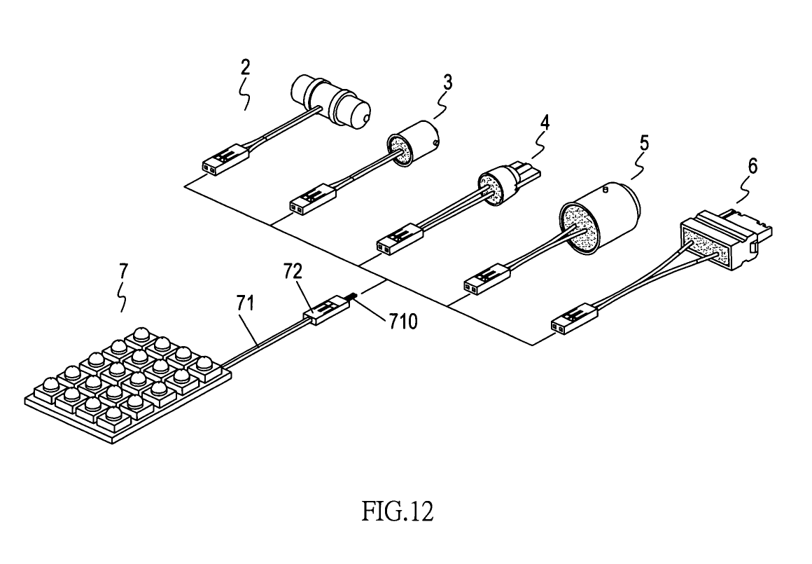

Referring to FIG. 12, another embodiment of the present invention is illustrated. An LED plate 7 is extended with a wire set 71 which is connected to a plug 72. The plug 72 is extended with two electrode pins 710. The electrode pins 710 are inserted into receptacles of the adaptors 2, 3, 4, 5 and 6.

Advantages of the present invention are that the present invention has a compact size, and moreover, it provides a buffer effect and is erode proof. The present invention can prolong the lifetime of the adaptors than the prior art. Furthermore the present invention has the effect of preventing power loss.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A car inside lamp adaptor device comprising:
an adaptor having a hollow seat and having a positive electrode and a negative electrode;
a wire set having an electrode pin at one end thereof and another end of the wire set extending with two wires which are connected to the positive electrode and negative electrode; respectively;
an elastic unit filling in a hollow seat and enclosing the positive electrode and negative electrode in an inner layer of the seat and being integrally formed with the seat; and
a cap for receiving one end of the electrode pin.

2. The car inside lamp adaptor device as claimed in claim 1, wherein the adaptor further comprising:
a ring in a hollow portion of the seat; one side of the seat having a via hole for receiving the wire set;
two cover posts being at two ends of the seat; one end of each post being an opening; an inner diameter of the opening is greater than an outer diameter of the seat; another end of the each post being a sealing end; a center of the sealing end being installed with an ejecting point; and
two springs being installed in the hollow center of the seat; one end of each spring being fixed to the ring in the seat and another end thereof being fixed to the post.

3. The car inside lamp adaptor device as claimed in claim 1, wherein the seat has a recess at one end thereof; another end of the seat has a rectangular block; one side of the block has a rib; and the block has two penetrating holes which are communicated to the recesses.

4. The car inside lamp adaptor device as claimed in claim 1, wherein a seat is a hollow cylinder; the seat has a positive electrode and a negative electrode; the elastic unit is filled in the seat; the elastic unit encloses the wire set so as to tightly adhere to an inner layer of the seat.

5. The car inside lamp adaptor device as claimed in claim 1, wherein an embedded seat has a hole at one end thereof; an outer surface of the seat has at least one recess and at least one rib; a lateral side of the seat is extended with a rectangular block; the block has two via hole which are communicated to the hole.

6. The car inside lamp adaptor device as claimed in claim 1, wherein the elastic unit is an interfere proof and wear tolerant epoxy.

7. The car inside lamp adaptor device as claimed in claim 1, wherein the hat is a male hat or a female hat.
